(19) United States
(12) Patent Application Publication
(10) Pub. No.: US 2005/0288447 A1
(43) Pub. Date: Dec. 29, 2005

(54) Modified propylene based polymer and polyolefin resin composition

(75) Inventors: Rikuo Onishi, Chiba (JP); Manabu Nomura, Chiba (JP); Yukuo Fujimoto, Chiba (JP); Takenori Fujimura, Chiba (JP)

Correspondence Address: Parkhurst & Wendel, Suite 210, 1421 Prince Street, Alexandria, VA, 22314-2805, US

(73) Assignee: IDEMITSU KOSAN CO., LTD., TOKYO (JP)

(21) Appl. No.: 10/526,771

(22) PCT Filed: Sep. 8, 2003
(86) PCT No.: PCT/JP03/11409

§ 371 Date: Mar. 8, 2005

(30) Foreign Application Priority Data
Sep. 9, 2002 (JP) 2002-263087
Sep. 9, 2002 (JP) 2002-263094

(51) Int. Cl. C08F 110/00

(52) U.S. Cl. 525/333.7; 524/502; 526/351

(57) ABSTRACT

A polyolefin resin composition including the following (A), (B) and (C), or the following (A), (B), (C) and (D): (A) a polymer synthesized from an α-olefin having 3 or more carbon atoms, (B) a modified propylene based polymer satisfying the following (1) to (4): (1) the content of polar group moieties resulting from a compound containing in the same molecule thereof an ethylenic double bond and a polar group is from 0.10 to 0.30 mmol/g,
(2) the intrinsic viscosity ([η]_{A}) measured at 135° C. in tetralin is from 0.8 to 3.0 dl/g, (3) the molecular weight distribution (Mw/Mn) is more than 2.5, and (4) the content of components having a molecular weight (Mw) of 10000 or less is 5% or less by weight, (C) an organized layer inorganic compound, and (D) a rubbery polymer.

### FIELD OF THE INVENTION

The present invention relates to a modified propylene based polymer and a polyolefin resin composition which are used in the field of industrial materials, wherein automobile materials about which a low specific gravity and high physical properties (such as mechanical properties and thermal properties) are required and engineering plastics are used; and processes for producing them.

### BACKGROUND ART

Hitherto, propylene based resin having physical properties (such as high heat resistance and high strength) equivalent to those of engineering plastics has been produced by compounding an inorganic filler, such as glass fiber or talc, and a propylene based polymer. In order to raise the balance between the above-mentioned properties up to a level of engineering plastics such as nylon, the following has been performed: an increase in the inorganic filler content therein, the use of a special inorganic filler, or the like. As a result, the physical property balance has been drastically improved. However, advantages which polypropylene originally has, such as a low specific gravity and a low price, have been considerably sacrificed.

Thus, development in the technique for the nano-dispersion of inorganic filler has been becoming active in order to aim to improve the physical property balance of polyolefin drastically without damaging excellent advantages thereof. For example, disclosed is the earliest technique wherein a lamellar clay mineral is dispersed into propylene resin up to a nano-order level so as to aim to improve physical properties thereof rapidly (see, for example, JP-A No. 6-41346) Techniques for improving the same technique are also disclosed (see, for example, JP-A No. 2001-240709, JP-A No. 2002-37940, and JP-A No. 2002-167484). All of these techniques are techniques wherein clay is homogeneously and highly dispersed (nano-dispersed) into propylene resin, which originally has no compatible property, thereby aiming to improve physical properties thereof.

However, these techniques have not yet arrived at a high physical property balance which is a target. From the viewpoint of resin design, it appears that the resins have a drawback that they are poor in flexibility.

Separately, trials for improving propylene based polymer itself have been made. For example, there are known acid-modified products wherein an unsaturated carboxylic acid or an anhydride thereof is added to propylene resin; and processes for producing the same. Most of the acid-modified products are highly acid-added products which have resin-reforming as an object and have a low molecular weight. Accordingly, the products cannot be used, as they are, as molded products.

Separately, trials for keeping physical properties of propylene based polymer and further producing a polymer having chemical reactivity have been slightly made.

There is a disclosed a technique for removing low molecular weight products, which are produced as byproducts by about 10% when polypropylene is modified with an unsaturated carboxylic acid or anhydride thereof and have a bad effect on physical properties, by (1) a method of dissolving the modified polypropylene into a solvent and then precipitating it in a poor solvent, or (2) a method of extracting the modified product while refluxing it with a specific solvent (see, for example, JP-A No. 63-90511). According to this technique, a large amount of low molecular weight products are produced as byproducts.

There is also disclosed a technique of using a dikentone compound in a large amount for modified polypropylene, the amount being 30 times that of the modified polypropylene, to remove the unreacted unsaturated carboxylic acid or anhydride thereof at a high temperature of 120° C. (see, for example, JP-A No. 2-185505). Furthermore, there is disclosed a technique of using a mixed solvent of a dikentone compound and an aromatic hydrocarbon in a large amount for modified polypropylene, the amount being 7 times that of the modified polypropylene, to remove the unreacted unsaturated carboxylic acid or anhydride thereof at a high temperature of 90 to 110° C. (see, for example, JP-A No. 4-202202). The two techniques have a drawback that the solvent is used in the large amount. Besides, the modified polypropylene may be melted and fused because of the high-temperature treatment.

As described above, the following have hardly been investigated: a process for producing an acid-modified propylene based polymer wherein low molecular weight products having a bad effect on physical properties thereof are hardly produced as byproducts; a process for removing the unreacted unsaturated carboxylic acid or anhydride thereof by use of a solvent in a small amount under mild conditions; and further active control of the balance between the amount of the added acid and properties (such as molecular weight and regularity) of the resin.

In light of the above-mentioned situation, the present invention has been made, and an object thereof is to provide a polyolefin resin composition having a high physical property balance without damaging properties of the polyolefin, and a process for producing the same.

Another object of the invention is to provide a modified propylene based polymer which is good in resin properties and hardly contains low molecular weight products as byproducts which have a bad effect on the physical properties, and a process for producing the same.

### DISCLOSURE OF THE INVENTION

According to the present invention, provided are the following modified propylene based polymer, polyolefin resin composition, and processes for producing them:

[1] A modified propylene based polymer satisfying the following (1) to (4):
(1) the content of polar group moieties resulting from a compound containing in the same molecule thereof an ethylenic double bond and a polar group is from 0.10 to 0.30 mmol/g,
(2) the intrinsic viscosity ([η]_{A}) measured at 135° C. in tetralin is from 0.8 to 3.0 dl/g,
(3) the molecular weight distribution (Mw/Mn) is more than 2.5, and
(4) the content of components having a molecular weight (Mw) of 10000 or less is 5% or less by weight.

[2] The modified propylene based polymer according to item [1], wherein the ratio of the intrinsic viscosity ([η]_{A}) thereof to the intrinsic viscosity ([η]_{S}) of a propylene based polymer which is a starting material of the modified polymer ([η]_{A}/[η]_{S}) is 0.2 or more.

[3] The modified propylene based polymer according to item [1] or [2], wherein the compound containing in the same molecule thereof an ethylenic double bond and a polar group is an unsaturated carboxylic acid and/or a derivative thereof.

[4] A process for producing the modified propylene based polymer according to any of items [1] to [3], which comprises: blending a propylene based polymer, a radical initiator, and a compound containing in the same molecule thereof an ethylenic double bond and a polar group; and melting and kneading the resultant at a temperature of not lower than the melting point of the propylene based polymer and less than 180° C.

[5] A polyolefin resin composition comprising the following (A), (B) and (C), or the following (A), (B), (C) and (D):
(A) a polymer synthesized from an α-olefin having three or more carbon atoms,
(B) the modified propylene based polymer according to any of items [1] to [3],
(C) an organized layer inorganic compound, and
(D) a rubbery polymer.

[6] The polyolefin resin composition according to item [5], wherein the melt flow rate of the α-olefin polymer (A) is from 0.1 to 200 g/10-minutes, and
the α-olefin polymer (A) is a homopolymer or a copolymer of a first α-olefin which has 3 or more carbon atoms and 0 to 20% by weight of a second α-olefin which is different from the first α-olefin and has 2 to 20 carbon atoms.

[7] A process for producing the polyolefin resin composition according to item [5] or [6], which comprises blending the (A), (B) and (C), or the (A), (B), (C) and (D); and then melting and kneading the resultant.

### BRIEF DESCRIPTION OF THE DRAWING

FIG. 1 is a schematic view of a biaxial extruder.

### BEST MODES FOR CARRYING OUT OF THE INVENTION

The polyolefin resin composition of the present invention is described hereinafter.

The resin composition of the present invention comprises the following (A), (B) and (C) or the following (A), (B), (C) and (D):
(A) a polymer synthesized from an α-olefin having three or more carbon atoms,
(B) a modified propylene based polymer satisfying the following (1) to (4):
   (1) the content of polar group moieties resulting from a compound containing in the same molecule thereof an ethylenic double bond and a polar group is from 0.10 to 0.30 mmol/g,
   (2) the intrinsic viscosity ([η]_{A}) measured at 135° C. in tetralin is from 0.8 to 3.0 dl/g,
   (3) the molecular weight distribution (Mw/Mn) is more than 2.5, and
   (4) the content of components having a molecular weight (Mw) of 10000 or less is 5% or less by weight,
(C) an organized layer inorganic compound, and
(D) a rubbery polymer.

First, the respective components of the composition of the invention are described.

Examples of the α-olefin polymer (A) include homopolymers of an α-olefin having 3 or more carbon atoms, preferably 3 to 20 carbon atoms; and random copolymers, block copolymers and graft copolymers of an α-olefin having 3 or more carbon atoms and an α-olefin which is different therefrom and has 2 to 20 carbon atoms, preferably 2 to 10 carbon atoms. The amount of the copolymerization moiety of the α-olefin having 2 to 20 carbon atoms is preferably from 0 to 20% by weight, more preferably from 0 to 10% by weight.

Specific examples of the α-olefin polymer (A) include homopolymers of propylene, 1-butene, and 4-methyl-1-pentene; and various copolymers of propylene and ethylene, and propylene and 1-butene or 4-methyl-1-pentene. Of these, preferable are a homopolymer of propylene and a block copolymer of propylene and ethylene. These may be used alone or in combination of two or more thereof.

The melt flow rate of the α-olefin polymer (A) is preferably from 0.1 to 200 g/10-minutes, more preferably from 1 to 100 g/10-minutes. If the rate is less than 0.1 g/10-minutes, the moldability of the composition may lower. On the other hand, if the rate is more than 200 g/10-minutes, the impact resistance of the composition may lower.

The α-olefin polymer (A) can be produced by any known process.

The modified propylene based polymer (B) satisfies the following (1) to (4):
(1) the content of polar group moieties resulting from a compound containing in the same molecule thereof an ethylenic double bond and a polar group (modifying agent) is from 0.10 to 0.30 mmol/g,
(2) the intrinsic viscosity ([η]_{A}) measured at 135° C. in tetralin is from 0.8 to 3.0 dl/g,
(3) the molecular weight distribution is more than 2.5, and
(4) the content of components having a molecular weight of 10000 or less is 5% or less by weight.

If the content of the polar group moieties is less than 0.10 mmol/g in the (1), the content of the polymer (B) needs to be made large in order to sufficiently obtain the effect of the polar group in the case that the moieties are used in combination with a different resin or a filler. Thus, economical efficiency is damaged. On the other hand, if the content is more than 0.30 mmol/g, at the time of producing the polymer the hue deteriorates and further the production stability and the adjustment of the molecular weight become difficult. In particular, in the case that the polymer is used in the composition of the invention, the exfoliative dispersion of the organized layer inorganic compound (C) is not sufficiently caused if the content is less than 10 mmol/g. On the other hand, if the content is more than 0.30 mmol/g, the compatibility with the α-olefin polymer (A) lowers. The content of the polar group moieties is preferably from 0.15 to 0.3 mmol/g, more preferably from 0.2 to 0.3 mmol/g.

The modifying agent, which constitutes the polar group moieties, will be described later.

If the intrinsic viscosity ([η]_{A}) is less than 0.8 dl/g in the (2), the following is caused: in the case of using the polymer alone or in combination with a different resin or a filler, a fall in dynamical properties thereof is easily caused. On the other hand, if the intrinsic viscosity is more than 3.0 dl/g, the following is caused: in the case of using the polymer alone or in combination with a different resin or a filler, the moldability thereof lowers or a gel is caused in the molded product. The intrinsic viscosity ([η]_{A}) is preferably from 0.9 to 2.5 dl/g, more preferably from 1.0 to 2.0 dl/g.

The ratio of the intrinsic viscosity ([η]_{A}) to the intrinsic viscosity ([η]_{S}) of the propylene based polymer which is a starting material of the modified polymer ([η]_{A}/[η]_{S}) is preferably 0.2 or more, more preferably 0.25 or more. If this ratio becomes less than 0.2, the molecular weight distribution of the modified polymer easily becomes 2.5 or less.

This ratio represents the degree of the cutting of molecular chains of the modified polymer. As this ratio is larger, the molecular chains of the modified polymer are less cut.

The propylene based polymer as the starting material, or the original propylene based polymer, will be described later.

If the molecular weight distribution (Mw/Mn) in the (3) is 2.5 or less, the composition is not easily oriented so that the rigidity thereof lowers. The molecular weight distribution is preferably more than 2.8, more preferably more than 3.0. Herein, Mw and Mn represent weight-average molecular weight and number-average molecular weight, respectively.

This molecular weight distribution (Mw/Mn) can be measured by, for example, gel permeation chromatography (GPC).

If the content of components having a molecular weight (Mw) of 10000 or less is more than 5% by weight in the (4), the impact resistance of the composition lowers. The molded product may get sticky or a deterioration in the surface quality thereof may be caused. This content of the components is preferably 3% less or less by weight, more preferably 2% or less by weight.

The content of components having a molecular weight (Mw) of 10000 or less means the content of components having a molecular weight (Mw) of 10000 or less in a GPC curve.

The modified propylene based polymer (B) preferably satisfies the following (5) to (6):
(5) the content of the modifying agent unreacted is not more than the limit of analysis, and
(6) the melting point is from 145 to 170° C.

The content of the unreacted modifying agent in the (5) can be obtained by the following operation.

The modified polymer is dissolved into paraxylene, and then precipitated in acetone. In this way, the operation for removing the unreacted modifying agent completely is conducted. This operation is repeated 5 times in total. The content of the polar group moieties in the modified polymer is quantitatively measured by the above-mentioned method. This quantitative amount is decided as the content of the modifying amount in the modified polymer containing no unreacted modifying agent (the solvent purifying method).

The matter that the content of the modifying agent unreacted is not more than the limit of analysis means that the content of the modifying agent in the modified polymer is within the range of the analytical error of the above-mentioned quantitative value.

If the melting point is lower than 145° C. in the (6), the following may be caused: in the case that the modified polymer is used alone or in combination with a different resin or a filler, a fall in the heat resistance thereof may be caused. The melting point is more preferably from 155 to 170° C.

This modified polymer (B) can be produced by blending an original propylene based polymer, a radical initiator, and a compound containing in the same molecule an ethylenic double bond and a polar group (a modifying agent), and melting and kneading the resultant at a temperature which is not lower than the melting point of the original propylene based polymer and less than 180° C.

Examples of the original propylene based polymer include propylene homopolymer; random copolymer, block copolymer and graft copolymer of propylene and α-olefin (such as ethylene, 1-butene, or 4-methyl-1-pentene); and mixtures thereof. Of these, preferable is propylene homopolymer.

The intrinsic viscosity ([η]_{S}) of the original propylene based polymer, which is measured at 135° C. in tetralin, is preferably 3 dl/g or more, more preferably from 4 to 10 dl/g. If the intrinsic viscosity is less than 3 dl/g, the content of the polar group moieties may lower (into 0.10 or less) or the molecular weight may lower (η<0.8).

The original propylene based polymer preferably satisfies the following (1) to (3):
(1) the content of components soluble in boiling heptane is not more than the limit of analysis,
(2) the molecular weight distribution (Mw/Mn) is 5 or less, and
(3) the content of components having a molecular weight (MW) of 1000000 or more is 25% or more by weight.

The matter that the content of components soluble in boiling heptane is not more than the limit of analysis means that the amount of the extraction-remaining polymer obtained by subjecting 10.000 g of the original polymer to Soxhlet extraction 5 times is within 10±0.002 g (the amount is substantially not more than the limit of analysis).

If the molecular weight distribution (Mw/Mn) is more than 5 in the (2), there is a large possibility that components having a molecular weight (MW) of 10000 or less in the modified polymer are produced as byproducts in an amount of more than 5% by weight. The molecular weight distribution is not particularly limited if the distribution is 5 or less. The distribution is more preferably from 3 to 5.

This molecular weight distribution can be calculated in the same way as the molecular weight distribution of the modified polymer.

If the content of components having a molecular weight (MW) of 1000000 or more is less than 25% by weight in the (3), the content of the polar group moieties may lower. This component content is not particularly limited if the content is 25% by weight. The component content is more preferably from 25 to 50% by weight.

The content of components having a molecular weight (MW) of 1000000 means the content of components having a molecular weight (MW) of 1000000 in a GPC curve.

Examples of the radical initiator include butylperoxide, α,α-bis(t-butylperoxy)diisopropylbenzene, benzoylperoxide, dichlorobenzoylperoxide, dicumylperoxide, t-butyl peracetate, t-butyl perdiethylacetate, t-butyl perisobutyrate, t-butylper-sec-octoate, t-butyl perpivarate, cumyl perpivarate, t-butyl perbenzoate, t-butyl perphenylacetate, t-butylcumylperoxide, di-t-butylperoxide, 1,1-di-t-butylperoxy-3,3,5-trimethylcyclohexane, 1,1-di-t-butylperoxycyclohexane, 2,2-di-(t-butylperoxy)butane, lauroylperoxide, 2,5-dimethyl-2,5-di(peroxybenzoate)hexyne-3, 1,3-bis(t-butylperoxyisopropyl)benzene, 1,4-bis(t-butylperoxyisopropyl)benzene, 2,5-dimethyl-2,5-di(t-butylperoxy)hexyne-3, 2,5-dimethyl-2,5-di(t-butylperoxy)hexane, 2,4,4-trimethylpentyl-2-hydroperoxide, diisopropylbenzenehydroperoxide, cumenehydroperoxide, 4,4-di-t-butylperoxyvaleric acid-n-butyl ester, di-t-butyl peroxyhexahydrophthalate, di-t-butyl peroxyazelate, t-butyl peroxy-3,3,5-trimethylhexoate, t-butyl peroxy-isopropylcarbonate, succinic acid peroxide, and vinyltris-(t-butylperoxy)silane. Of these, preferable are 1,3-bis(t-butylperoxyisopropyl)benzene, 2,5-dimethyl-2,5-di(t-butylperoxy)hexyne-3, dicumylperoxide, α,α-bis(t-butylperoxy)diisopropylbenzene, and 2,5-dimethyl-2,5-di (t-butylperoxy) hexane. These may be used alone or in combination of two or more thereof.

Examples of the polar group contained in the modifying agent include carboxylic acid, carboxylic acid anhydride, carboxylic acid ester, carboxylic acid halide, carboxylic acid amide, carboxylic acid imide, carboxylic acid salt, sulfonic acid, sulfonic acid ester, sulfonic acid chloride, sulfonic acid amide, sulfonic acid salt, epoxy, amino, and oxazolin groups. Of these, preferable are carboxylic acid and carboxylic acid anhydride groups.

The modifying agent used in the present invention is not particularly limited, and is preferably an unsaturated carboxylic acid having the above-mentioned polar group, and/or a derivative thereof.

Examples of the unsaturated carboxylic acid or the derivative thereof are unsaturatedmono- or di-carboxylic acids, or derivatives thereof. Specific examples of these derivatives include anhydrides, esters, halides, amides, imides and salts of the carboxylic acids. Of these, preferable are unsaturated dicarboxylic acids or anhydrides thereof.

Specific examples of the unsaturated mono-or di-carboxylic acid include acrylic acid, methacrylic acid, maleic acid, endo-bicyclo[2.2.1]-5-heptene-2,3-dicarboxylic acid (endic acid), fumaric acid, tetrahydrophthalic acid, itaconic acid, citraconic acid, crotonic acid, isocrotonic acid, and nasic acid.

Specific examples of the derivative of the unsaturated carboxylic acid include malenyl chloride, maleimide, maleic anhydride, endic anhydride, methyl acrylate, acrylic amide, methyl methacrylate, glycidyl methacrylate, methacrylic amide, citraconic anhydride, itaconic anhydride, nasic anhydride, monomethyl maleate, dimethyl maleate, monomethyl fumarate, and dimethyl fumarate.

Of these unsaturated carboxylic acids or the derivatives thereof, acrylic acid, methacrylic acid and maleic anhydride are preferable and maleic anhydride is more preferable. These may be used alone or in combination of two or more thereof.

When the modified polymer is produced, the radical initiator is added preferably in an amount of 0.1 to 5 parts by weight, more preferably in an amount of 0.5 to 2 parts by weight for 100 parts by weight of the original polymer. If the added amount is less than 0.1 part by weight, the content of the polar groups may lower. On the other hand, if the amount is more than 5 parts by weight, the molecular weight may lower and further the molecular weight distribution (Mw/Mn) may turn into 2.5 or less.

The modifying agent is added preferably in an amount of 1.5 to 10 parts by weight, more preferably in an amount of 2 to 6 parts by weight for 100 parts by weight of the original polymer. If the added amount is less than 1.5 parts by weight, the content of the polar groups may lower. On the other hand, if the amount is more than 10 parts by weight, the remaining amount of the unreacted modifying agent becomes large and further the stability of the production may lower. Furthermore, the hue of the resultant product may deteriorate largely.

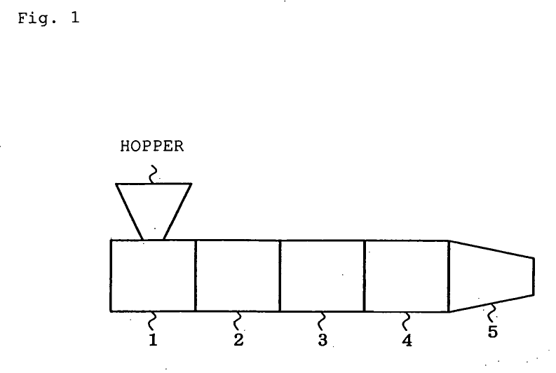

The method for blending the respective components is not particularly limited. An example thereof is a dry blending method. After the blending, for example, a biaxial extruder illustrated in FIG. 1 is used to melt and knead the blended components at a temperature which is not lower than the melting point of the original polymer and lower than 180° C. At the time of the melting and kneading, the temperature of the resin from a section 1 under a hopper of a biaxial extruder cylinder to a plasticizing-zone fore-section 2 is set to a temperature of 150° C. or lower, and the temperature of the resin from the plasticizing zones 3 and 4 of the cylinder to a die 5 thereof is set to a temperature which is not lower than the melting point of the original polymer and less than 180. At this time, the resin temperature of the section 1 under the hopper is preferably 130° C. or lower, more preferably 100° C. or lower and particularly preferably from room temperature to 60° C. in order to prevent the modifying agent from being scattered.

If the melting and kneading temperature is set to 180° C. or higher, the following is caused: in the case that the original polymer is modified to set the content of the polar group moieties in the modified polymer into the above-mentioned range, the molecular weight distribution easily becomes 2.5 or less. The melting and kneading temperature means the temperature of the highest temperature zone in the biaxial extruder cylinder. In FIG. 1, the highest temperature zone is a zone that exists between the die 5 to the plasticizing zones 3 and 4.

The melting and kneading (retention) time is preferably from 10 to 120 seconds.

At the time of the melting and kneading, the mixture is preferably put into an inert gas atmosphere. At this time, steam may be added thereto or volatile components may be removed therefrom under a reduced pressure.

As the molding machine, a monoaxial extruder, a biaxial extruder or the like is used.

Examples of the biaxial extruder include a 20 mm Laboplast mill, and a 35 mm TEM (biaxial extruder manufactured by Toshiba Machine Co., Ltd.).

When the modified propylene based polymer (B) is produced by such a method, it is unnecessary to use a super high molecular weight polymer as the starting material for the production thereof. Moreover, production stability and a reduction in costs can be attained at the time of the production since the decomposition ratio of the starting material and others is small. Furthermore, an improvement in the hue of the modified polymer can be expected since the using amount of the radical generator (peroxide) can be decreased.

Since the modified propylene based polymer of the invention has a high molecular weight and keep properties of the original polymer thereof, the polymer can be used as a film or a molded product. Low molecular weight products less bleed out since the polymer hardly contains the modifying agent unreacted and contains a small amount of the low molecular weight products. Accordingly, the polymer can be used for applications in which bleeding-out becomes a problem, such as a film.

Since the modified propylene based polymer of the invention has not only these characteristics but also characteristics that the content of the polar group moieties is large and the molecular weight distribution is wide, the polymer is suitable as a material of polyolefin nano-composites. Even if the modified polymer of the invention is incorporated in a large amount when a nano-composite is produced, a fall in physical properties thereof can be remarkably restrained.

In other words, the modified propylene based polymer (B) has characteristics of a high polar group moiety content, a high molecular weight and a wide molecular weight distribution and a characteristic that the content of low molecular weight components is small. The use of the modified polymer having such characteristics is effective for improving the physical property balance of the composition of the invention.

The organized layer inorganic compound (C) may be, for example, a compound wherein interlayer cations of a lamellar silicate are substituted with alkylammonium. The lamellar silicate may be a lamellar clay mineral. Specific examples thereof include smectite lamellar clay minerals such as montmorillonite, bentonite, saponite, hectorite, beidellite, stevensite, and nontronite; vermiculite; halloysite; mica; and fluorides thereof. These may be natural materials or synthetic materials.

The lamellar silicate is preferably a swelling silicate, wherein interlayer cations are easily substituted with alkylammonium. The cation exchange capacity of the lamellar silicate is preferably 70 meq./100 g or more, more preferably from 85 to 250 meq./100 g.

Specific examples of the lamellar silicate which is preferably used include montmorillonite, bentonite, swelling mica, and swelling fluorine mica. Montmorillonite and swelling fluorine mica are particularly preferable.

The interlayer cations are cations which the lamellar silicate holds between its layers, and examples thereof include potassium, sodium, calcium and barium ions.

Examples of the alkylammonium include a hexylammonium ion, an octylammonium ion, a 2-ethylhexylammonium ion, a dodecylammonium ion, an octadecylammonium ion, a dioctyldimethyl ammonium ion, a trioctylammonium ion, a stearylammonium ion, and distearylammonium ion. Of these, preferable are octadecylammonium ion, dioctyldimethyl ammonium ion, trioctylammonium ion, stearylammonium ion, and distearylammonium ion.

A part or all of the interlayer cations may be substituted, and the substituted amount is preferably 50% or more of the interlayer cations, more preferably from 80 to 100% thereof.

The organized layer inorganic compound (C) can be produced by any known method. For example, the compound can be yielded by mixing a suspension wherein the above-mentioned lamellar silicate is dispersed in water with an aqueous solution of the above-mentioned alkylammonium salt, causing them to react at room temperature for 30 minutes to 5 hours while stirring the mixture, solid/liquid-separating a solid content from the reaction solution, and washing and drying the solid content. When the lamellar silicate is mixed with the alkylammonium salt, the alkylammonium salt is mixed preferably in an equivalent 0.5 to 1.5 times the cation exchange capacity of the lamellar silicate, more preferably in an equivalent 0.8 to 1.2 times the cation exchange capacity.

Since the organized layer inorganic compound (C) is a compound wherein interlayer cations are substituted with alkylammonium, the distance between layers thereof is wider than that of the lamellar silicate before the substitution. When the organized layer inorganic compound (C) in such a state is blended with the modified propylene based polymer (B), chains of a portion of the modified propylene based polymer (B) are bonded to the organized layer inorganic compound (C) or go into spaces between its layers. As a result, the distance between the layers in the organized layer inorganic compound (C) is further enlarged in the composition. In the invention, this organized layer inorganic compound (C) is homogeneously and finely dispersed in the composition by shearing stress received at the time of the melting and kneading.

One kind of the organized layer inorganic compound (C) may be used alone or two or more kinds thereof may be used in combination.

Examples of the rubbery polymer (D) include olefin elastomers such as ethylene/propylene rubber; olefin plastomers such as ethylene/1-octene copolymer; and styrene elastomers such as hydrogenated styrene/butadiene block copolymer (SEBS). Of these, preferable are styrene elastomers and more preferable is hydrogenated styrene/butadiene block copolymer. These may be used alone or in combination of two or more thereof.

If necessary, the following additives may be added to the composition of the invention: a nuclei agent, an antioxidant, an ultraviolet absorbent, an external lubricant, a plasticizer, an antistatic agent, a coloring agent, a flame retardant, a flame retardation auxiliary, and others. Examples of the nuclei agent include aluminum di (p-t-butylbenzoate) and other carboxylic acid metal salts, sodium methylenebis(2,4-di-t-butylphenol) acid phosphate and other phosphoric acid metal salts, talc, and phthalocyanine derivatives. Examples of the plasticizer include polyethylene glycol, polyamide oligomer, ethylenebisstearoamide, phthalic acid esters, polystyrene oligomer, polyethylene wax, mineral oil, and silicone oil. Examples of the flame retardant include bromopolystyrene, syndiotactic bromopolystyrene, and bromopolyphenylene ether. Examples of the flame retardation auxiliary include antimony trioxide, and other antimony compounds. Examples of the antioxidant include (2,6-di-t-butyl-4-methylphenyl)pentaerythritol diphosphite (PEP-36, manufactured by Adeka Argos Chemical Corporation) and other phosphorus-based antioxidants, tetrakis[methylene-3-(3′,5′-di-t-butyl-4′-hydroxyphenyl)]propionate (MARK A060, manufactured by Adeka Argos Chemical Corporation) and other hindered phenolic antioxidants. These additives may be used alone or in combination of two or more thereof.

The following describes the process for producing the composition of the invention.

The composition of the invention can be produced by blending the above-mentioned respective components and then melting and kneading the resultant. The method for blending the respective components, the temperature at the melting and kneading, the time therefor and other producing conditions are not particularly limited, and can be appropriately adjusted.

In the composition comprising the α-olefin polymer (A), the modified propylene based polymer (B) and the organized layer inorganic compound (C), the blended amounts of the respective components are as follows: the amount of the (A) component is preferably from 50 to 95 parts by weight, more preferably from 50 to 85 part-s by weight; that of the (B) component is preferably from 4 to 50 parts by weight, more preferably from 10 to 50 parts by weight; and that of the (C) component is preferably from 1 to 30 parts by weight, more preferably from 5 to 20 parts by weight.

In the composition comprising the α-olefin polymer (A), the modified propylene based polymer (B), the organized layer inorganic compound (C) and the rubbery polymer (D), the blended amounts are as follows: the amount of the (A) component is preferably from 30 to 95 parts by weight, more preferably from 40 to 75 parts by weight; that of the (B) component is preferably from 4 to 50 parts by weight, more preferably from 10 to 50 parts by weight; that of the (C) component is preferably from 1 to 30 parts by weight, more preferably from 5 to 20 parts by weight; and that of the (D) component is preferably from 5 to 40 parts by weight, more preferably from 10 to 30 parts by weight.

If the blended amount of the (A) component is less than 50 parts by weight or 30 parts by weight, costs increase and the balance between rigidity and impact resistance may lower. On the other hand, if the amount is more than 95 parts by weight, the effect of the (C) component is not easily exhibited and further the balance between rigidity and impact resistance may lower.

If the blended amount of the (B) component is less than 4 parts by weight, the exfoliative dispersion of the (C) component may become difficult. On the other hand, if the amount is more than 50 parts by weight, costs increase and further physical properties such as impact resistance may deteriorate.

If the blended amount of the (C) component is less than 1 part by weight, the effect of an improvement in the rigidity of the composition may become small. On the other hand, if the amount is more than 30 parts by weight, the exfoliative dispersion of the (C) component may become difficult and the effect of a reduction in the weight of the composition may become small.

If the blended amount of the (D) component is less than 5 parts by weight, the impact resistance of the resultant product may lower. On the other hand, if the amount is more than 40 parts by weight, the rigidity may lower.

In the composition of the invention, the blended amount of the organized layer inorganic compound (C) can be made small by the incorporation of the modified propylene based polymer (B); therefore, the characteristic that the α-olefin polymer has a low specific gravity is not damaged. Since the organized layer inorganic compound (C) can be dispersed to a high degree, the rigidity, the impact resistance, the heat resistance and other physical properties can be kept at a high level and with a good balance. The composition of the invention, which has a low specific gravity, exhibits performances equivalent to or more than those of conventional high specific gravity polypropylene composites (such as talc-filled polypropylene).

The composition of the invention is suitable as automobile materials for bumpers, instrument panels and others, or industrial materials for which engineering plastic is used.

### EXAMPLES

Examples of the present invention are described hereinafter. However, the invention is not limited by these examples.

The content of polar group moieties in any modified propylene based polymer, the intrinsic viscosity [η]_{A} thereof, the molecular weight distribution (Mw/Mn) thereof, the content of components having a molecular weight (Mw) of 10000 or less (LP amount) therein, intrinsic viscosity [η]_{S} of original propylene based polymer of the modified propylene based polymer, and the melting point thereof were measured by the following methods.

(1) Content of Polar Group Moieties

Any modified polymer was molded into a film, and it was used to measure the Fourier transform infrared absorption spectrum thereof, thereby calculating the content.

(2) Intrinsic Viscosity [η]_{A}, [η]_{S}

It was measured at 135° C. in tetralin.

(3) Mw/Mn and LP Amount

The Mw/Mn was calculated from the Mw and Mn in terms of polypropylene, measured with a device and conditions described below. The LP amount was obtained as the amount of components having a molecular weight (Mw) of 10000 or less in the GPC curve.

(GPC Measuring Device)

Column: TOSOGMHHR—H(S)HT
Detector: an RI detector for liquid chromatography
   Waters 150C
   (Measuring Conditions)
Solvent: 1,2,4-trichlorobenzene
Temperature: 145° C.
Flow rate: 1.0 mL
Sample concentration: 2.2 mg/mL
Injected amount: 160 μL
Calibration curve: Univesal Calibration
Analytical program: HT-GPC (Ver. 1.0)
   (4) Melting Point

A differential scanning calorimeter (DSC) was used to melt a sample at 220° C. under nitrogen gas flow for 3 minutes. Thereafter, the temperature thereof was lowered down to 25° C. at 10° C./minute. The sample was kept at 25° C. for 3 minutes, and then the temperature was raised at 10° C./minute. The melting point was obtained as the peak top of a melting endothermic curve obtained as above.

The melt flow rates (M.I.) of propylene based polymers (A-1 and A-2) were measured at a resin temperature of 230° C. and a load of 2.16 kg in accordance with JIS-K7210.

### Production Example 1

[Synthesis of Original Propylene Based Polymer]

(1) Preparation of a Preliminary Polymerization Catalyst Component

A three-necked flask having an internal volume of 0.5 liter and equipped with an agitator was substituted with nitrogen gas, and subsequently thereto were added 400 mL of heptane subjected to dehydration treatment, 18 g of diethylaluminum chloride, and 2 g of a commercially available Solvay type titanium trichloride catalyst (manufactured by Tosoh Finechem Corp.). The internal temperature was kept at 20° C., and propylene was added to the solution while the solution was stirred. After 80 minutes, the stirring was stopped to yield a preliminary polymerization catalyst component wherein 0.8 g of propylene was polymerized per gram of the solid catalyst.

(2) Synthesis of an Original Propylene Based Polymer

A stainless steel autoclave having an internal volume of 10 L and equipped with an agitator was sufficiently dried, and substituted with nitrogen. Thereafter, 6 L of heptane subjected to dehydration treatment was added thereto, and then the nitrogen in the system was substituted with propylene. Thereafter, 0.06 MPaG of hydrogen was added thereto, and then propylene was introduced thereinto while the solution was stirred. The inside of the system was stabilized into an internal temperature of 65° C. and a propylene pressure of 0.75 MPaG. Thereafter, thereto was added 50 mL of a heptane slurry containing 0.5 g of the preliminary polymerization catalyst component prepared in the (1), the amount of this catalyst component being an amount in terms of the solid catalyst. While propylene was continuously added thereto, polymerization was conducted at 65° C. for 1.5 hours.

Next, after the internal temperature was set to 50° C. and the stirring was weakened, the pressure was reduced. Thereafter, 0.04 MPaG of hydrogen was added thereto. Propylene was then introduced thereinto while the solution was stirred. While propylene was continuously supplied into the system at an internal temperature of 50° C. and a propylene pressure of 0.75 MPaG, polymerization was conducted at 50° C. for 6 hours. After the end of the polymerization, 50 mL of methanol was added to the system, and then the temperature was lowered and the pressure was reduced. The whole amount of the content was transferred into a filtrating vessel with a filter. The temperature thereof was raised to 85° C., and the content was separated into a solid and a liquid. Furthermore, the solid content was washed 2 times with 6 L of heptane at 85° C. of temperature, and vacuum-dried to yield 2.1 kg of a propylene based polymer. The intrinsic viscosity [η]_{S} of this polymer was 4.02 dl/g, and the melting point was 162° C. The catalyst activity per gram of the solid catalyst was 4.2 kg/g-cat.·7.5 hours according to the 7.5-hour polymerization. Under the same conditions as described above, polymerization of propylene was repeated. The resultant polymer was used as an original propylene based polymer.

### Production Example 2

[Synthesis of Original Propylene Based Polymer]

An original propylene based polymer was synthesized in the same way as in Production Example 1 except that the hydrogen pressures in the first stage and the second stage in Production Example 1(2) were changed to 0.03 MPaG and 0.025 MPaG, respectively. The intrinsic viscosity [η]_{S} of this polymer was 6.05 dl/g, and the melting point was 161° C.

### Production Example 3

[Synthesis of Original Propylene Based Polymer]

(1) Preparation of a Solid Catalyst Component

A three-necked flask having an internal volume of 0.5 liter and equipped with an agitator was substituted with nitrogen gas, and subsequently thereto were added 60 mL of octane subjected to dehydration treatment, and 16 g of diethoxy magnesium. The system was heated to 40° C., and thereto was added 2.4 mL of silicon tetrachloride. The slurry was stirred for 20 minutes, and subsequently thereto was added 1.6 mL of dibutyl phthalate. The temperature of this system was raised to 80° C., and subsequently thereto was dropwise added 77 mL of titanium tetrachloride. The slurry was stirred at an internal temperature of 125° C. for 2 hours to conduct contact operation. Thereafter, the stirring was stopped to precipitate a solid. The supernatant was removed. Thereto was added 100 mL of dehydrated octane, and the temperature of the resultant was raised up to 125° C. while stirred. This state was kept for 1 minute and then the stirring was stopped to precipitate a solid. The supernatant was removed. This washing operation was repeated 7 times. Furthermore, 122 mL of titanium tetrachloride was added to the resultant, and this mixture was stirred at an internal temperature of 125° C. for 2 hours to conduct a second contact operation. Thereafter, the above-mentioned washing with dehydrated octane of 125° C. temperature was repeated 6 times to yield a solid catalyst component.

(2) Preparation of a Preliminary Polymerization Catalyst Component

A three-necked flask having an internal volume of 0.5 liter and equipped with an agitator was substituted with nitrogen gas, and subsequently thereto were added 400 mL of heptane subjected to dehydration treatment, 25 mmol of triisobutylaluminum, 2.5 mmol of dicyclopentyldimethoxysilane, and 4 g of the solid catalyst component prepared in the (1). At room temperature, propylene was introduced into the resultant solution while the solution was stirred. After one hour, the stirring was stopped to yield a preliminary polymerization catalyst component wherein 4 g of propylene was polymerized per gram of the solid catalyst component.

(3) Synthesis of an Original Propylene Based Polymer

A stainless steel autoclave having an internal volume of 10 L and equipped with an agitator was sufficiently dried, and substituted with nitrogen. Thereafter, thereto were added 6 L of heptane subjected to dehydration treatment, 12.5 mmol of triethylaluminum, and 0.3 mmol of dicyclopentyldimethoxysilane. After nitrogen in the system was substituted with propylene, propylene was introduced thereinto while the solution was stirred. The inside of the system was stabilized into an internal temperature of 80° C. and a total pressure of 0.8 MPaG. Thereafter, thereto was added 50 mL of a heptane slurry containing 0.08 mmol of the preliminary polymerization catalyst component prepared in the (2), the amount of this catalyst component being an amount in terms of Ti atoms. While propylene was continuously supplied thereto, polymerization was conducted at 80° C. for 3 hours.

After the polymerization, 50 mL of methanol was added to the system. The temperature was lowered and the pressure was reduced. The whole amount of the content was transferred into a filtrating vessel with a filter. The temperature thereof was raised to 85° C., and the content was separated into a solid and a liquid. Furthermore, the solid content was washed 2 times with 6 L of heptane of 85° C. temperature, and vacuum-dried to yield 2.5 kg of a propylene based polymer. The intrinsic viscosity [η]_{S} of this polymer was 7.65 dl/g, and the melting point was 164° C. The catalyst activity per gram of the solid catalyst component was 9.8 kg/g-cat.·3 hours according to the 3-hour polymerization. Under the same conditions as described above, polymerization of propylene was repeated. The resultant polymer was used as an original propylene based polymer.

### Example 1

### [Synthesis of Maleic Anhydride Modified Propylene Based Polymer]

To 100 parts by weight of the original propylene based polymer synthesized in Production Example 1 were added 5 parts by weight of maleic anhydride, and 2.5 parts by weight of a Perkadox 14-40C (trade name, 1,3-bis-(t-butylperoxyisopropyl)benzene/calcium carbonate: 40/60(ratio by weight), manufactured by Kayaku Akzo Corp.). The components were dry-blended, and melted and kneaded by use of a 35 mm biaxial extruder. The temperature of the biaxial extruder at the time of the melting and kneading was set as follows: a section under a hopper, 40° C.; a plasticizing-zone fore-section, 120° C.; a plasticizing zone, 170° C.; and a die, 180° C. These portions correspond to the portions to which reference numbers are attached in FIG. 1.

To 100 parts by weight of the resultant pellet-form sample were added 50 parts by weight of acetone and 50 parts by weight of heptane, and then the resultant was heated and stirred at 85° C. for 2 hours, (which was carried out in a pressure-resistant vessel). After the end of this operation, the pellets were collected with a metal wire gauze, and then dipped in 100 parts by weight of acetone for 15 hours. Thereafter, the pellets were collected with a metal wire gauze, air-dried, and then vacuum-dried at 80° C. for 6 hours and at 130° C. for 6 hours to yield a maleic anhydride modified propylene based polymer. Physical properties thereof are shown in Table 1.

### Example 2

### [Synthesis of Maleic Anhydride Modified Propylene Based Polymer]

A maleic anhydride modified propylene based polymer was synthesized in the same way as in Example 1 except that the blending amount of the Perkadox 14-40C was changed to 1.5 parts by weight in Example 1. Physical properties thereof are shown in Table 1.

### Example 3

### [Synthesis of Maleic Anhydride Modified Propylene Based Polymer]

A maleic anhydride modified propylene based polymer was synthesized in the same way as in Example 1 except that the original propylene based polymer synthesized in Production Example 2 was used instead of the original propylene based polymer synthesized in Production Example 1. Physical properties thereof are shown in Table 1.

### Comparative Example 1

### [Synthesis of Maleic Anhydride Modified Propylene Based Polymer]

To 100 parts by weight of the original propylene based polymer synthesized in Production Example 3 were added 1 part by weight of maleic anhydride, and 1 part by weight of a Kayabutyl B (trade name, t-butyl peroxybenzoate, manufactured by Kayaku Akzo Corp.). The components were dry-blended, and melted and kneaded by use of a 35 mm biaxial extruder. About the temperature of the biaxial extruder at the time of the melting and kneading, all of the temperatures of the section under the hopper, the plasticizing-zone fore-section, the plasticizing zone, and the die were set to 210° C.

To 100 parts by weight of the resultant pellet-form sample were added 50 parts by weight of acetone and 50 parts by weight of heptane, and then the resultant was heated and stirred at 85° C. for 2 hours (which was carried out in a pressure-resistant vessel). After the end of this operation, the pellets were collected with a metal wire gauze, and then dipped in 100 parts by weight of acetone for 15 hours. Thereafter, the pellets were collected with a metal wire gauze, air-dried, and then vacuum-dried at 80° C. for 6 hours and at 130° C. for 6 hours to yield a maleic anhydride modified propylene based polymer. Physical properties thereof are shown in Table 1.

### Comparative Example 2

To 100 parts by weight of the original propylene based polymer synthesized in Production Example 3 were added 5 parts by weight of maleic anhydride, and 5 parts by weight of the Perkadox 14-40C. The components were dry-blended, and melted and kneaded by use of a 35 mm biaxial extruder under the same conditions as in Comparative Example 1. To 100 parts by weight of the resultant pellet-form sample were added 50 parts by weight of acetone and 50 parts by weight of heptane, and then the resultant mixture was heated and stirred at 85° C. for 2 hours (which was carried out in a pressure-resistant vessel). After the end of this operation, the pellets were collected with a metal wire gauze, and then dipped in 100 parts by weight of acetone for 15 hours. Thereafter, the pellets were collected with a metal wire gauze, air-dried, and then vacuum-dried at 80° C. for 6 hours and at 130° C. for 6 hours to yield a maleic anhydride modified propylene based polymer. Physical properties thereof are shown in Table 1.

TABLE 1
Modified polymer

| | | Example | Example | Example | Comparative | Comparative |
|---|---|---|---|---|---|---|
| Items | unit | 1 | 2 | 3 | Example 1 | Example 2 |
| Content of | mmol/g | 0.15 | 0.13 | 0.20 | 0.08 | 0.10 |
| polar group | | | | | | |
| moieties | | | | | | |
| [η]_{A} | dl/g | 0.86 | 1.18 | 1.21 | 0.70 | 0.72 |
| Mw/Mn | — | 3.2 | 3.4 | 3.5 | 1.9 | 1.9 |
| LP amount | % by | 2.6 | 1.4 | 2.7 | 2.3 | 2.0 |
| | weight | | | | | |
| [η]_{A}/[η]_{S} | — | 0.21 | 0.29 | 0.30 | 0.09 | 0.09 |

### Examples 4 to 18 and Comparative Examples 3 to 9

[Preparation of Polypropylene Resin Composition]

Some of propylene based polymers (A), modified propylene based polymers (B), organized layer inorganic compounds (C), and rubbery polymers (D) described below were blended at respective blend ratios shown in Tables 2 and 3. Thereafter, the resultants were melted and kneaded at 230° C. by use of a biaxial extruder, so as to prepare propylene resin compositions.

The used propylene based polymer (A) were the following A-1 and A-2:
A-1: high-impact polypropylene (propylene/ethylene block copolymer) (J784H (trade name) manufactured by Idemitsu Petrochemical Co., Ltd., copolymerization moiety content: 12% by weight, M.I.: 10 g/10-minutes), and
A-2: propylene homopolymer (J3000GP (trade name) manufactured by Idemitsu Petrochemical Co., Ltd, M.I.: 30 g/10-minutes)

The used modified propylene based polymers (B) were the following B-1 to B-7:
B-1: maleic anhydride modified propylene polymer synthesized in Example 1,
B-2: maleic anhydride modified propylene polymer synthesized in Example 2,
B-3: maleic anhydride modified propylene polymer synthesized in Example 3,
B-4: maleic anhydride modified propylene polymer commercially available (Polybond 3200 (trade name) manufactured by Crompton Corp., polar group moiety content: 0.048 mmol/g, [η]_{A}: 0.76 dl/g, Mw/Mn: 2.4, LP amount: 4.0% by weight),
B-5: maleic anhydride modified propylene polymer commercially available (Umex 1010 (trade name) manufactured by Sanyo Chemical Industries, Ltd., polar group moiety content: 0.43 mmol/g, [η]_{A}: 0.19 dl/g, Mw/Mn: 4.1, LP amount: 43.5% by weight),
B-6: maleic anhydride modified propylene polymer synthesized in Comparative Example 1, and
B-7: maleic anhydride modified propylene polymer synthesized in Comparative Example 2.

The used organized layer inorganic compounds (C) were the following C-1 and C-2:
C-1: montmorillonite (Kunipia F (trade name) manufactured by Kunimine Industries Co., Ltd., organic ammonium salts: 40% by weight), and
C-2: swelling synthetic mica (Somasif (trade name) manufactured by Co-op Chemical Co., Ltd.), swelling fluorine mica, organic ammonium salts: 30% by weight).

The used rubbery polymers (D) were the following D-1 and D-2:
D-1: ethylene-propylene copolymer rubber (EP02P (trade name) manufactured by Nippon Gosei Gomu (Japan Synthetic Rubber Co., Ltd.)), and
D-2: SEBS (Kraton G1652 (trade name) manufactured by Shell Chemicals Japan Ltd.).
   [Physical Properties]

About the resultant polypropylene compositions, the following (1) to (3) (the following (1) to (2) about the compositions of Examples 1 to 18 and Comparative Examples 7 to 9) were evaluated. The evaluation results are shown in Tables 2 and 3.)
(1) Flexural modulus: it was in accordance with JIS K7203.)
(2) Izod impact strength: it was in accordance with JIS K7110 (23° C., with a notch)

(3) Heat deflecion temperature: it was in accordance with JIS K7207.

TABLE 2

| | | | | | | | | | | | Com- | Com- | Com- | Com- |
|---|---|---|---|---|---|---|---|---|---|---|---|---|---|---|
| | | | | | | | | | | | para- | para- | para- | para- |
| | | | | | | | | | | | tive | tive | tive | tive |
| | | | | Exam- | Exam- | Exam- | Exam- | Exam- | Exam- | Exam- | Exam- | Exam- | Exam- | Exam- |
| | | Items | Unit | ple 4 | ple 5 | ple 6 | ple 7 | ple 8 | ple 9 | ple 10 | ple 3 | ple 4 | ple 5 | ple 6 |
| Compo- | Compo- | Kind | — | A-1 | A-1 | A-1 | A-1 | A-1 | A-2 | A-1 | A-1 | A-1 | A-1 | A-1 |
| sition | nent A | Blend | Parts by | 65 | 65 | 65 | 50 | 50 | 65 | 65 | 65 | 65 | 65 | 50 |
| | | amount | weight | | | | | | | | | | | |
| | Compo- | Kind | — | B-1 | B-2 | B-3 | B-1 | B-1 | B-1 | B-1 | B-4 | B-5 | B-6 | B-7 |
| | nent B | Blend | Parts by | 30 | 30 | 30 | 50 | 50 | 30 | 30 | 30 | 30 | 30 | 50 |
| | | amount | weight | | | | | | | | | | | |
| | Compo- | Kind | — | C-1 | C-1 | C-1 | C-1 | C-1 | C-1 | C-2 | C-1 | C-1 | C-1 | C-1 |
| | nent C | Blend | Parts by | 8 | 8 | 8 | 8 | 20 | 8 | 7 | 8 | 8 | 8 | 8 |
| | | amount | weight | | | | | | | | | | | |

| | | | | | | | | | | | | | |
|---|---|---|---|---|---|---|---|---|---|---|---|---|---|
| Physical | Flexural | MPa | 2710 | 2680 | 2620 | 2960 | 4340 | 3290 | 3450 | 1880 | 2410 | 2240 | 2330 |
| properties | modulus | | | | | | | | | | | | |
| | Izod | KJ/m² | 5.4 | 6.5 | 7.1 | 4.6 | 3.1 | 2.2 | 4.9 | 5.0 | 1.9 | 4.2 | 2.8 |
| | impact | | | | | | | | | | | | |
| | strength | | | | | | | | | | | | |
| | Heat | ° C. | 138 | 135 | 132 | 134 | 140 | 142 | 140 | 124 | 109 | 128 | 129 |
| | deflec- | | | | | | | | | | | | |
| | tion on | | | | | | | | | | | | |
| | temper- | | | | | | | | | | | | |
| | ature | | | | | | | | | | | | |

TABLE 3

| | | | | | | | | | | | | Com- | Com- | Com- |
|---|---|---|---|---|---|---|---|---|---|---|---|---|---|---|
| | | | | | | | | | | | | para- | para- | para- |
| | | | | | | | | | | | | tive | tive | tive |
| | | | | Exam- | Exam- | Exam- | Exam- | Exam- | Exam- | Exam- | Exam- | Exam- | Exam- | Exam- |
| | | Items | Unit | ple 11 | ple 12 | ple 13 | ple 14 | ple 15 | ple 16 | ple 17 | ple 18 | ple 7 | ple 8 | ple 9 |
| Compo- | Compo- | Kind | — | A-1 | A-1 | A-1 | A-1 | A-1 | A-2 | A-1 | A-1 | A-1 | A-1 | A-1 |
| sition | nent A | Blend | Parts by | 55 | 55 | 55 | 50 | 40 | 55 | 55 | 55 | 55 | 55 | 50 |
| | | amount | weight | | | | | | | | | | | |
| | Compo- | Kind | — | B-1 | B-2 | B-3 | B-1 | B-1 | B-1 | B-1 | B-1 | B-4 | B-5 | B-7 |
| | nent B | Blend | Parts by | 25 | 25 | 25 | 50 | 40 | 25 | 25 | 25 | 25 | 25 | 50 |
| | | amount | weight | | | | | | | | | | | |
| | Compo- | Kind | — | C-1 | C-1 | C-1 | C-1 | C-1 | C-1 | C-2 | C-1 | C-1 | C-1 | C-1 |
| | nent C | Blend | Parts by | 8 | 8 | 8 | 8 | 20 | 8 | 8 | 8 | 8 | 8 | 8 |
| | | amount | weight | | | | | | | | | | | |
| | Compo- | Kind | — | D-1 | D-1 | D-1 | D-1 | D-1 | D-1 | D-1 | D-2 | D-1 | D-1 | D-1 |
| | nent D | Blend | Parts by | 15 | 15 | 15 | 15 | 15 | 15 | 15 | 15 | 15 | 15 | 15 |
| | | amount | weight | | | | | | | | | | | |

| | | | | | | | | | | | | | |
|---|---|---|---|---|---|---|---|---|---|---|---|---|---|
| Physical | Flexural | MPa | 1820 | 1730 | 1690 | 1910 | 3800 | 2660 | 2010 | 1790 | 1010 | 1610 | 1490 |
| properties | modulus | | | | | | | | | | | | |
| | Izod | KJ/m² | 54 | 62 | 74 | 40 | 18 | 8.9 | 48 | 68 | 50.0 | 5.6 | 34 |
| | impact | | | | | | | | | | | | |
| | strength | | | | | | | | | | | | |

The compositions of Comparative Examples 3 to 9 were poorer in the balance between the physical properties than the compositions of Examples 4 to 18 since no modified polymer satisfying the requirements of the present invention was used in the former compositions.

### INDUSTRIAL APPLICABILITY

According to the present invention, it is possible to provide a modified propylene based polymer which is excellent in resin properties and hardly comprises, as byproducts, low molecular weight products producing a bad effect on physical properties, and a process for producing the same.

According to the invention, it is possible to provide a polyolefin resin composition having a high physical property balance without damaging characteristics of polyolefin, and a process for producing the same.

1. A modified propylene based polymer satisfying the following (1) to (4):
(1) the content of polar group moieties resulting from a compound containing in the same molecule thereof an ethylenic double bond and a polar group is from 0.10 to 0.30 mmol/g,
(2) the intrinsic viscosity ([η]_{A}) measured at 135° C. in tetralin is from 0.8 to 3.0 dl/g,
(3) the molecular weight distribution (Mw/Mn) is more than 2.5, and
(4) the content of components having a molecular weight (Mw) of 10000 or less is 5% or less by weight.

2. The modified propylene based polymer according to claim 1, wherein the ratio of the intrinsic viscosity ([η]_{A}) thereof to the intrinsic viscosity ([η]_{S}) of a propylene based polymer which is a starting material of the modified polymer ([η]_{A}/[η]_{S}) is 0.2 or more.

3. The modified propylene based polymer according to claim 1, wherein the compound containing in the same molecule thereof an ethylenic double bond and a polar group is an unsaturated carboxylic acid and/or a derivative thereof.

4. A process for producing the modified propylene based polymer according to claim 1, which comprises: blending a propylene based polymer, a radical initiator, and a compound containing in the same molecule thereof an ethylenic double bond and a polar group; and melting and kneading the resultant at a temperature of not lower than the melting point of the propylene based polymer and less than 180° C.

5. A polyolefin resin composition comprising the following (A), (B) and (C), or the following (A), (B), (C) and (D):
(A) a polymer synthesized from an α-olefin having 3 or more carbon atoms,
(B) the modified propylene based polymer according to claim 1,
(C) an organized layer inorganic compound, and
(D) a rubbery polymer.

6. A polyolefin resin composition comprising the following (A), (B) and (C), or the following (A), (B), (C) and (D):
(A) a polymer synthesized from an α-olefin having 3 or more carbon atoms,
(B) the modified propylene based polymer according to claim 2,
(C) an organized layer inorganic compound, and
(D) a rubbery polymer.

7. A polyolefin resin composition comprising the following (A), (B) and (C), or the following (A), (B), (C) and (D):
(A) a polymer synthesized from an α-olefin having 3 or more carbon atoms,
(B) the modified propylene based polymer according to claim 3,
(C) an organized layer inorganic compound, and
(D) a rubbery polymer.

8. The polyolefin resin composition according to claim 5, wherein the melt flow rate of the α-olefin polymer (A) is from 0.1 to 200 g/10-minutes, and
the α-olefin polymer (A) is a homopolymer or a copolymer of a first α-olefin which has 3 or more carbon atoms and 0 to 20% by weight of a second α-olefin which is different from the first α-olefin and has 2 to 20 carbon atoms.

9. A process for producing the polyolefin resin composition according to claim 5, which comprises blending the (A), (B) and (C), or the (A), (B), (C) and (D); and then melting and kneading the resultant.
